(19) United States
(12) Patent Application Publication
(10) Pub. No.: US 2023/0024824 A1
(43) Pub. Date: Jan. 26, 2023

(54) ANALYSIS APPARATUS, ANALYSIS METHOD, AND NON-TRANSITORY COMPUTER READABLE MEDIUMSTORING ANALYSIS PROGRAM

(71) Applicant: NEC Corporation, Minato-ku, Tokyo (JP)

(72) Inventors: Hirofumi UEDA, Tokyo (JP); Ryo Mizushima, Tokyo (JP); Tomohiko Yagyu, Tokyo (JP)

(73) Assignee: NEC Corporation, Minato-ku, Tokyo (JP)

(21) Appl. No.: 17/785,487

(22) PCT Filed: Dec. 25, 2019
(86) PCT No.: PCT/JP2019/050981

§ 371 Date: Jun. 15, 2022

(51) Int. Cl. G06F 21/57

(52) U.S. Cl. CPC G06F 21/577; G06F 2221/034

(57) ABSTRACT

An analysis apparatus (10) includes: a setting unit (11) configured to set virtual vulnerabilities in a plurality of nodes configuring an information system to be analyzed; an extraction unit (12) configured to extract an attack route of the information system based on the virtual vulnerabilities set by the setting unit (11); and a discrimination unit (13) configured to discriminate vulnerabilities to be monitored based on the virtual vulnerabilities in the extracted attack route extracted by the extraction unit (12).

### TECHNICAL FIELD

The present disclosure relates to an analysis apparatus, an analysis method, and a non-transitory computer readable medium storing an analysis program.

### BACKGROUND ART

In recent years, there has been a significant increase in cyberattacks that attack vulnerabilities in information systems, which increases threat to cybersecurity. Therefore, as the information systems including control systems and IoT (Internet of Things) continue to become more diverse and more complex, a major issue is how to address the ever-increasing vulnerabilities in the information systems.

As related techniques, for example, Patent Literatures 1 and 2 are known. Patent Literature 1 describes that in a security diagnostic system, intrusion routes to the information assets of a target system are searched for, and a list of vulnerabilities in the intrusion routes is displayed. Further, Patent Literature 2 describes that in a network vulnerability inspection apparatus, vulnerability test data of unknown vulnerabilities and previously-undiscovered security holes is automatically created, and a vulnerability test of the inspection target network equipment is conducted.

### CITATION LIST

### Patent Literature

Patent Literature 1: Japanese Unexamined Patent Application Publication No. 2008-257577
Patent Literature 2: Japanese Unexamined Patent Application Publication No. 2005-354338

### SUMMARY OF INVENTION

### Technical Problem

In the related techniques such as those described in Patent Literatures 1 and 2, in order to analyze vulnerabilities in an information system, intrusion routes are searched for and vulnerability tests are conducted. However, the related techniques are techniques for extracting vulnerabilities that are obviously present in the assets of the information system or vulnerabilities that are already-discovered, and thus there is a problem that it is difficult to grasp the vulnerabilities that may have an impact on the information system (vulnerabilities that are not yet confirmed of their existence but if discovered, may have an impact on the system).

The present disclosure has been made in view of the problem mentioned above, and an object of the present disclosure is to provide an analysis apparatus, an analysis method, and a non-transitory computer readable medium storing an analysis program, each of the apparatus, the method, and the program being adapted to grasp vulnerabilities that may have an impact on an information system.

### Solution to Problem

An analysis apparatus according to the present disclosure includes:

setting means for setting virtual vulnerabilities in a plurality of nodes configuring an information system to be analyzed;

extraction means for extracting an attack route of the information system based on the set virtual vulnerabilities; and

discrimination means for discriminating vulnerabilities to be monitored based on the virtual vulnerabilities in the extracted attack route.

An analysis method according to the present disclosure includes:

setting virtual vulnerabilities in a plurality of nodes configuring an information system to be analyzed;

extracting an attack route of the information system based on the set virtual vulnerabilities; and

discriminating vulnerabilities to be monitored based on the virtual vulnerabilities in the extracted attack route.

A non-transitory computer readable medium according to the present disclosure stores an analysis program for causing a computer to execute the processing of:

setting virtual vulnerabilities in a plurality of nodes configuring an information system to be analyzed;

extracting an attack route of the information system based on the set virtual vulnerabilities; and

discriminating vulnerabilities to be monitored based on the virtual vulnerabilities in the extracted attack route.

### Advantageous Effects of Invention

According to the present disclosure, it is possible to provide an analysis apparatus, an analysis method, and a non-transitory computer readable medium storing an analysis program, each of the apparatus, the method, and the program being adapted to grasp vulnerabilities that may have an impact on an information system.

### BRIEF DESCRIPTION OF DRAWINGS

FIG. 1 is a flowchart showing a related vulnerability management method;

FIG. 2 is a configuration diagram showing an outline of an analysis apparatus according to example embodiments;

FIG. 3 is a diagram for describing the vulnerability types according to a first example embodiment;

FIG. 4 is a schematic diagram showing a configuration diagram of an analysis system according to the first example embodiment;

FIG. 5 is a diagram showing an example of virtual vulnerabilities according to the first example embodiment;

FIG. 6 is a flowchart showing an operation example of the analysis system according to the first example embodiment;

FIG. 7 is a diagram showing a configuration example of an information system that is analyzed by the analysis system according to the first example embodiment;

FIG. 8 is a diagram for describing a method of analyzing an attack route according to the first example embodiment;

FIG. 9 is a diagram showing an example of analytical elements in an attack route according to the first example embodiment;

FIG. 10 is a diagram showing an example of an attack graph according to the first example embodiment;

FIG. 11 is a diagram showing an example of virtual vulnerabilities in the attack route according to the first example embodiment;

FIG. 12 is a diagram showing an example of virtual vulnerabilities in the attack route according to the first example embodiment;

FIG. 13 is a diagram showing a display example of an analysis result according to the first example embodiment;

FIG. 14 is a diagram showing a display example of an analysis result according to the first example embodiment; and

FIG. 15 is a configuration diagram showing an outline of hardware of a computer according to example embodiments.

### DESCRIPTION OF EMBODIMENTS

Hereinbelow, example embodiments will be described with reference to the example embodiments. In the drawings, the same structural elements are denoted by the same reference symbols and redundant explanations thereof are omitted where appropriate.

(Study Leading to Example Embodiments)

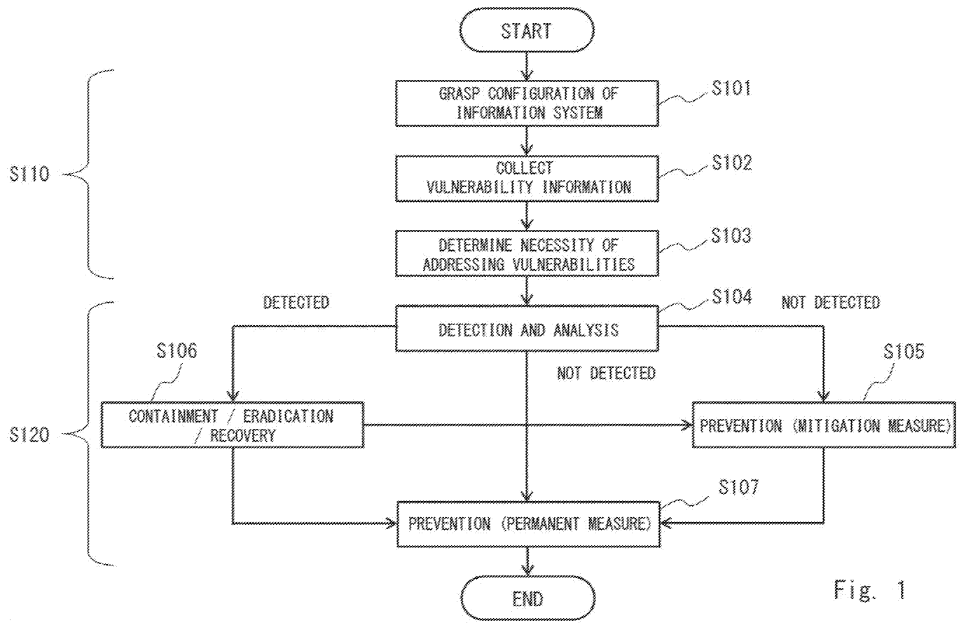

First, management of vulnerabilities in information systems are investigated. FIG. 1 shows a related vulnerability management method. This method is mainly performed by an administrator.

As shown in FIG. 1, in the related vulnerability management method, a vulnerability of a target information system is first recognized (S110), and the recognized vulnerability is addressed (S120).

In the recognition of the vulnerability (S110), a configuration of the information system is acquired (S101). Software and hardware included in the information system are acquired by referring to a detailed design document of the information system and obtaining system configuration information of the information system.

Next, vulnerability information of the information system is collected (S102). The vulnerability information of the acquired software and hardware is collected from alert information by IPA (Information-technology Promotion Agency), public databases of vulnerability information such as CVE (Common Vulnerabilities and Exposures) and NVD (National Vulnerability Database).

Next, it is determined whether or not the vulnerabilities need to be addressed (S103). Based on the collected vulnerability information, it is determined whether or not the vulnerabilities of the software and the hardware should be addressed in the information system.

When it is determined that a countermeasure is needed, detection and analysis (S104) of an attack exploiting the vulnerability are performed as a countermeasure against the vulnerability (S120). By referring to a log of the information system, it is confirmed whether there is any trace of the attack which exploited the corresponding vulnerability. Depending on a result of the detection of the attack exploiting the vulnerability and the details of the vulnerability, necessary countermeasures such as prevention (mitigation measure) (S105), containment/eradication/recovery (S106), and prevention (permanent measure) (S107) shall be taken. In the prevention (mitigation measure) (S105), filtering of IP (Internet Protocol) addresses and URLs (Uniform Resource Locators) is set in the information system. The containment/eradication/recovery (S106) involve incident handling. In the prevention (permanent measure) (S107), a patch is installed in the information system.

With such a management method, for example, when a new vulnerability is discovered, an impact on the information system is assessed, and the administrator determines whether or not the vulnerability needs to be addressed. Safety of information systems can be maintained by addressing newly discovered vulnerabilities.

However, since the vulnerabilities in the information system are continuing to increase year by year, the number of the vulnerabilities which the administrators need to check for are increasing, and it is getting more difficult to determine whether or not vulnerabilities need to be addressed. That is, in the related techniques, every time vulnerability is discovered, impact of the newly discovered vulnerability on the information system is determined, and so all the newly discovered vulnerabilities must be checked (monitored) for their impacts on the information system.

Therefore, in the following example embodiments, by grasping and monitoring only the vulnerabilities that may have an impact on the information system, it is possible to reduce the burden of vulnerability management.

(Outline of Example Embodiments)

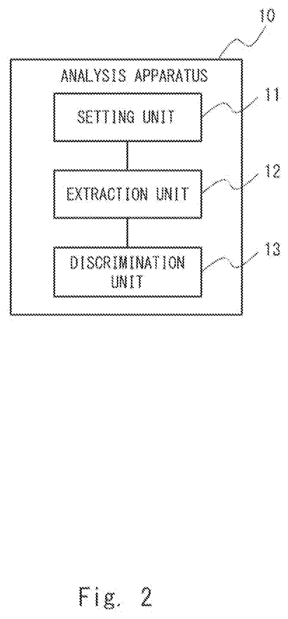

FIG. 2 shows an outline of an analysis apparatus according to the example embodiments. As shown in FIG. 2, an analysis apparatus 10 according to the example embodiments includes a setting unit 11, an extraction unit 12, and a discrimination unit 13.

The setting unit 11 sets virtual vulnerabilities in nodes constituting an information system. The extraction unit 12 extracts an attack route of the information system based on the virtual vulnerabilities set by the setting unit 11. For instance, the extraction unit 12 extracts, using an attack route generation technique (an attack graph generation technique), a potential attack route in the information system to which the virtual vulnerabilities are set.

The discrimination unit 13 discriminates the vulnerabilities to be monitored based on the virtual vulnerabilities in the node in the attack route extracted by the extraction unit 12. For example, the discrimination unit 13 grasps the list of vulnerabilities that appear in a section of the extracted attack route from the starting point of the attack to the end of the attack, and in the list of vulnerabilities that appear in a section of the extracted attack route, the vulnerabilities that are already-discovered/previously-undiscovered at the current stage are investigated, and the undiscovered vulnerabilities are considered to be vulnerabilities to be monitored.

As described above, potential attack routes are extracted based on the virtual vulnerabilities that are pseudo vulnerabilities and by discriminating the virtual vulnerabilities in the extracted attack routes, it is possible to grasp the vulnerabilities that could establish an attack route in the information system, that is, it is possible to grasp the vulnerabilities that could have an impact on the information system.

### First Example Embodiment

Hereinbelow, a first example embodiment will be described with reference to the drawings.

<Classification of Vulnerability Types>

First, in order to facilitate understanding of the present example embodiment, how the vulnerabilities (the vulnerability information) are handled in the present example embodiment will be described. In the present example embodiment, the vulnerabilities are classified into predetermined types that are arbitrary determined based on the content of the attack. While various vulnerabilities are already discovered for each software (product) and for content of each attack, the vulnerabilities can be classified into several types based on the “attack category” and the “impact of exploitation”. The “attack category” is a category such as remote attack/local attack and the like (an intrusion method). The “impact of exploitation” refers to an impact on the system when the vulnerabilities are exploited (the result of the attack).

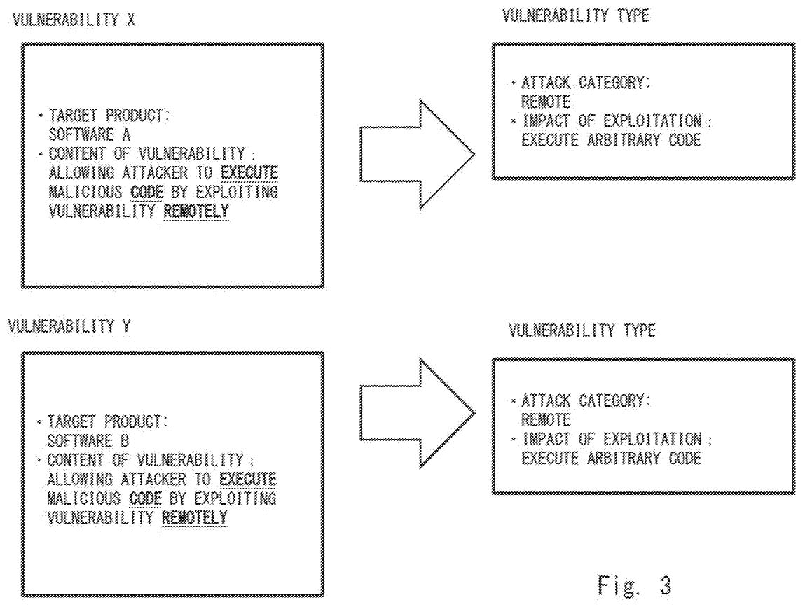

FIG. 3 shows a specific example of the classification of the types of vulnerabilities. For example, as the vulnerability information acquired from the public databases and the like, there are vulnerability information X and vulnerability information Y as shown in FIG. 3. The vulnerability information includes the “target product”, which is the target of the attack and the “content of the vulnerability”, which is the details of the vulnerability. The target products of the vulnerability X and the vulnerability Y are “software A” and “software B”, respectively, and while the target products differ, the contents of the vulnerabilities are the same, that is “allowing an attacker to execute a malicious code by exploiting the vulnerabilities remotely”. Therefore, when the “attack category” and the “impact of exploitation” are extracted from the contents of the vulnerabilities and the vulnerability X and the vulnerability Y are classified by their types, the vulnerability type of the vulnerability X falls under the category of “remote” for the attack category and under the category of “arbitrary code execution” for the impact of exploitation, and the vulnerability type of the vulnerability Y and the impact of exploitation of the vulnerability Y fall also under the same attack category and the same impact of exploitation as those of the vulnerability X.

As described above, by converting the vulnerabilities (the vulnerability information) into the vulnerability types, even when the vulnerabilities are different from one another, they can be handled as the same type. In the present example embodiment, as a way of analyzing the vulnerabilities, there is a method of discriminating the types of the vulnerabilities of the node in the attack route to thereby grasp the impact of the vulnerabilities on the information system. For example, when the types of the vulnerabilities that could be exploited in an attack can be discriminated, that is, when there is vulnerability of a type that could be attacked if discovered, such type of vulnerability is to be monitored.

<System Configuration>

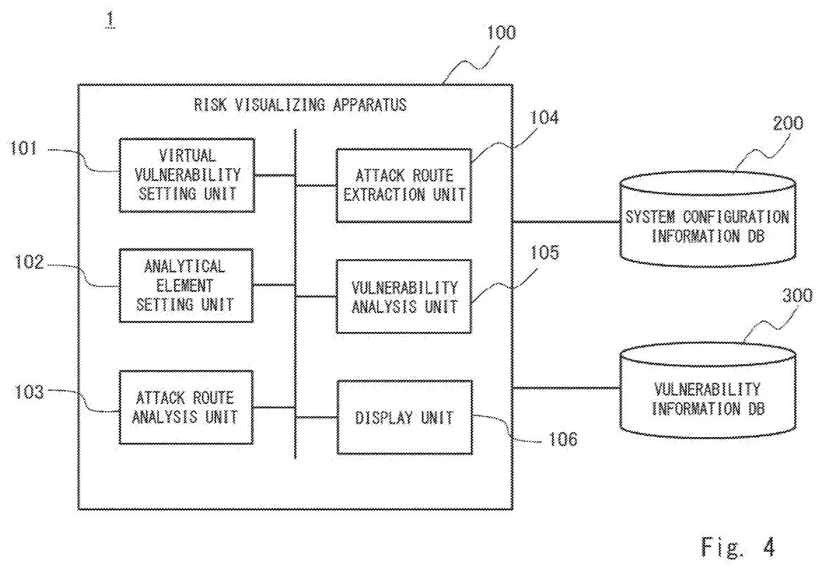

FIG. 4 is a configuration example of an analysis system 1 according to the present example embodiment. The analysis system 1 according to the present example embodiment analyzes the potential vulnerabilities (the attack route) in the information system to be analyzed and visualizes the analysis result.

As shown in FIG. 4, the analysis system (the analysis apparatus) 1 includes a risk visualizing apparatus 100, a system configuration information DB (database) 200, and a vulnerability information DB 300. The system configuration information DB 200 and the vulnerability information DB 300 may be connected to the risk visualizing apparatus 100 via a network such as the internet or may be directly connected to the risk visualizing apparatus 100. Further, the system configuration information DB 200 and the vulnerability information DB 300 may be storage devices incorporated in the risk visualizing apparatus 100.

The system configuration information DB 200 is a database for storing, in advance, the system configuration information of the information system to be analyzed. The system configuration information includes hardware information, software information, network information, various setting information, and the like of node devices (terminals) constituting the information system.

The vulnerability information DB 300 is a database for storing the vulnerability information of already-discovered (disclosed) vulnerability. As shown in, for instance, FIG. 3, the vulnerability information includes the target product and the content of the vulnerability for each vulnerability. Further, the vulnerability information is classified into vulnerability types (attack category and impact of exploitation) in advance. The vulnerability information DB 300 may store, in addition to the vulnerability information that is made public by public organizations such as IPA, CVE, NVD, and JVN (Japan Vulnerability Notes), vulnerability information that is made public by security vendors and other vendors. Further, as long as the vulnerability information that is made public can be acquired, the configuration is not limited to databases and may be any configuration such as a blog.

The risk visualizing apparatus 100 includes a virtual vulnerability setting unit 101, an analysis element setting unit 102, an attack route analysis unit 103, an attack route extraction unit 104, a vulnerability analysis unit 105, and a display unit 106. Note that other configuration may be adopted as long as the operations described later can be performed.

The virtual vulnerability setting unit 101 sets the virtual vulnerabilities in the nodes constituting the information system to be analyzed. The virtual vulnerabilities are vulnerability type of virtual (pseudo) vulnerabilities. The virtual vulnerabilities encompass vulnerabilities of all possible vulnerability types, that is, the virtual vulnerabilities include all of the prescribed vulnerability types into which the vulnerabilities are classified. By setting the above-described virtual vulnerabilities, it is possible to extract all potential attack routes.

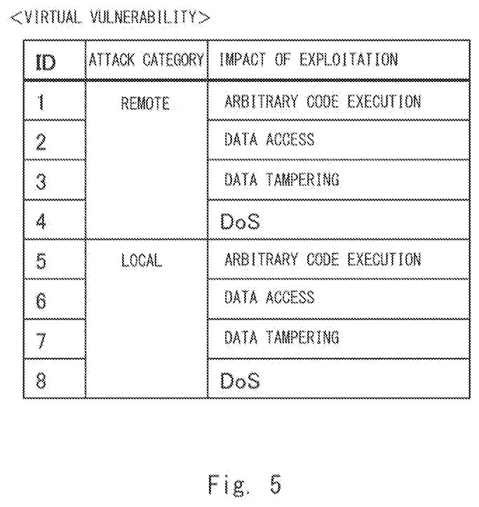

FIG. 5 shows a specific example of virtual vulnerabilities. The vulnerability type includes the “attack category” and the “impact of exploitation”, and the virtual vulnerabilities are every combination of the type of “attack category” and the type of “impact of exploitation”. For example, there are two types of attack category of “remote” and “local”, and there are four types of impact of exploitation of “arbitrary code execution”, “data access”, “data tampering”, and “Dos (Denial of Service)”. In this case, as shown in FIG. 5, eight types of vulnerabilities are the virtual vulnerabilities. Note that FIG. 5 is a mere example and other types of virtual vulnerabilities may be included as necessary. For example, the “administrator privileges”, “general-user privileges”, and the like may be included in the attack category, or the “privilege escalation” and the like may be included in the impact of exploitation.

In order to generate the attack graph, the analysis element setting unit 102 sets analysis elements such as an intrusion point (entry point) of the attack route in the information system and an attack target. For example, the analysis elements may be set in advance or may be set by a user operation or the like. The attack route analysis unit 103 analyzes the attack route (the attack path) based on the analysis elements such as the set intrusion point and attack target. The attack path extraction unit 104 generates the attack graph by using the attack graph generation technique (attack graph generation tool) based on the analysis result, and extracts all potential attack routes from the generated attack graph. The attack graph is a graph showing attack steps assumed for the information system to be analyzed is applied, and nodes passing through the attack steps in order from the intrusion point to the attack target are connected. The connection route of the nodes from the intrusion point to the attack target in the attack graph is the attack route.

The vulnerability analysis unit (the discrimination unit) 105 analyzes the virtual vulnerabilities in the extracted attack route and discriminates the vulnerabilities to be monitored. The vulnerability analysis unit 105 discriminates the vulnerability to be monitored based on whether the virtual vulnerability in the attack route is vulnerability that is already discovered or not. When the virtual vulnerability in the attack route is previously-undiscovered vulnerability, the vulnerability analysis unit 105 determines that monitoring is to be performed for such undiscovered virtual vulnerability.

The display unit (the output unit) 106 is a display apparatus that displays the analysis result and the like and displays the discriminated vulnerability to be monitored and the like using the GUI (Graphical User Interface) and the like. For example, the display unit 106 distinguishably displays the vulnerability to be monitored in the attack route and the other vulnerabilities in the attack route. The display unit 106 is a liquid crystal display, an organic EL display, or the like and may be an external device of the risk visualizing apparatus 100. Note that the monitoring targets and the like may be output not only by displaying but also by other methods (by e-mails, data transmission or the like).

<Operation of System>

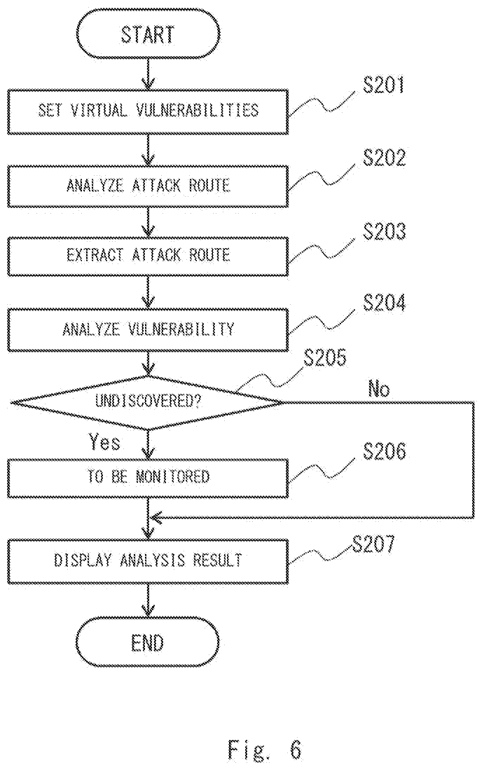

FIG. 6 shows an operation example (an analysis method) of the analysis system 1 according to the present example embodiment. As shown in FIG. 6, first, the risk visualizing apparatus 100 sets the virtual vulnerabilities (S201). The virtual vulnerability setting unit 101 generates the virtual vulnerabilities (the virtual vulnerability information) including all vulnerability types (e.g. 8 types) shown in FIG. 5. Further, the virtual vulnerability setting unit 101 acquires the system configuration information of the information system to be analyzed from the system configuration information DB 200 and sets the generated virtual vulnerabilities in each node configuring the information system. The node is a device such as a terminal or a server that could be the target whose vulnerabilities are exploited and is, for instance, a hardware but it may be a software.

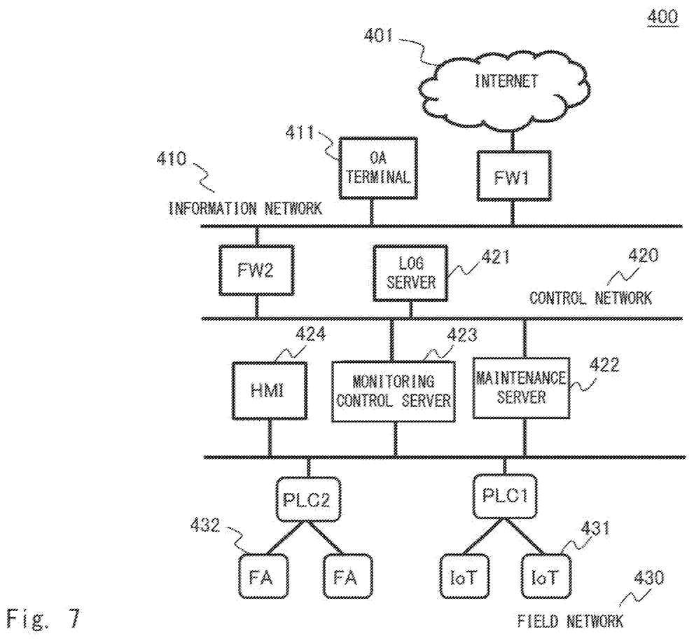

FIG. 7 shows a configuration example of an information system to be analyzed. As shown in FIG. 7, for instance, the information system 400 is a production management system including an information network 410, a control network 420, and a field network 430. The information network 410 is connected to the internet 401 via a firewall FW1 and includes an OA terminal 411. The control network 420 is connected to the information network 410 via a firewall FW2, and includes a log server 421, a maintenance server 422, a monitoring control server 423, and an HMI (Human Machine Interface) 424. The field network 430 is connected to the control network 420 via programmable logic controllers PLC1 and PLC2, and includes IoT device 431, FA (Factory Automation) device 432, and the like.

The virtual vulnerability setting unit 101 sets the virtual vulnerabilities in every node in the information system 400. In this example, virtual vulnerabilities are set in the OA terminal 411, the log server 421, the maintenance server 422, the monitoring control server 423, the HMI 424, the IoT device 431, and the FA device 432. Note that when the virtual vulnerabilities are applicable, the virtual vulnerabilities may be set in the firewalls FW1 and FW2, repeaters such as the programmable logic controllers PLC1 and PLC2, and the like.

Next, the risk visualizing apparatus 100 analyzes the attack route (S202). The analysis element setting unit 102 sets analytical elements such as the intrusion point of the attack route and the target of attack, and the attack route analysis unit 103 analyzes the attack route based on the set analytical elements.

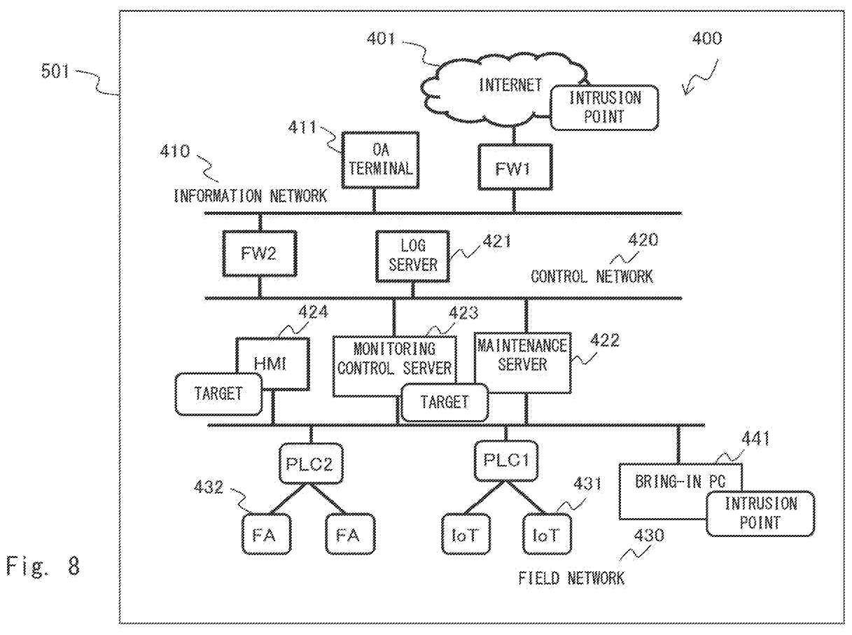

For example, the display unit 106 displays a display screen 501 like that shown in FIG. 8, which enables the user to set the analytical elements via the GUI of the display screen 501. In the example shown in FIG. 8, the system configuration of the information system 400 is displayed on the display screen 501, and the user selects the node to thereby set the analytical elements such as the intrusion point and the attack target. Nodes may be added to the information system as necessary. For instance, the internet 401 and a newly added bring-in PC (Personal Computer) 411 may be set as the intrusion point of attack and the monitoring control server 423 and the HMI 424 may be set as the attack targets.

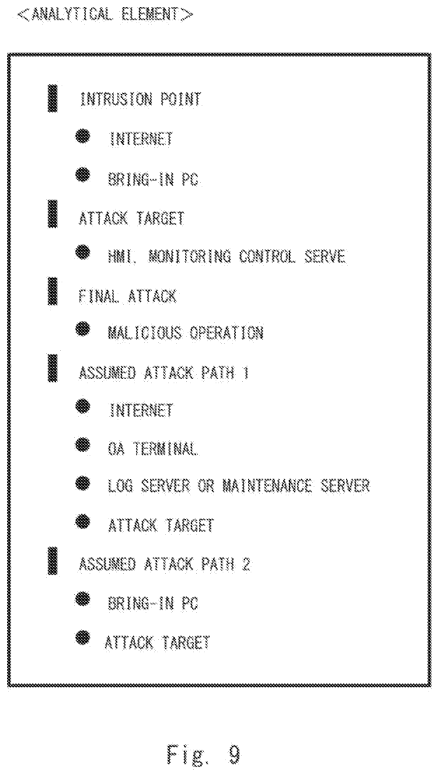

The attack route analysis unit 103 may analyze the attack route from the set intrusion point and the attack target or may analyze the arbitrarily designated attack route. For example, as the analytical elements, as shown in FIG. 9, in addition to the intrusion point and the attack target, the final attack (the result of the attack), the assumed attack path (the attack route) between the nodes, and the like are set, and the attack route is analyzed.

Next, the risk visualizing apparatus 100 extracts the attack route (S203). The attack route extraction unit 104 generates an attack graph using the attack graph generation technique based on the information that is set and analyzed and extracts all potential attack routes. That is, by inputting the system configuration information to which the virtual vulnerabilities are set to the attack graph generation technique, an attack graph showing an attack from the intrusion point to the attack target via the virtual vulnerabilities of the nodes is generated.

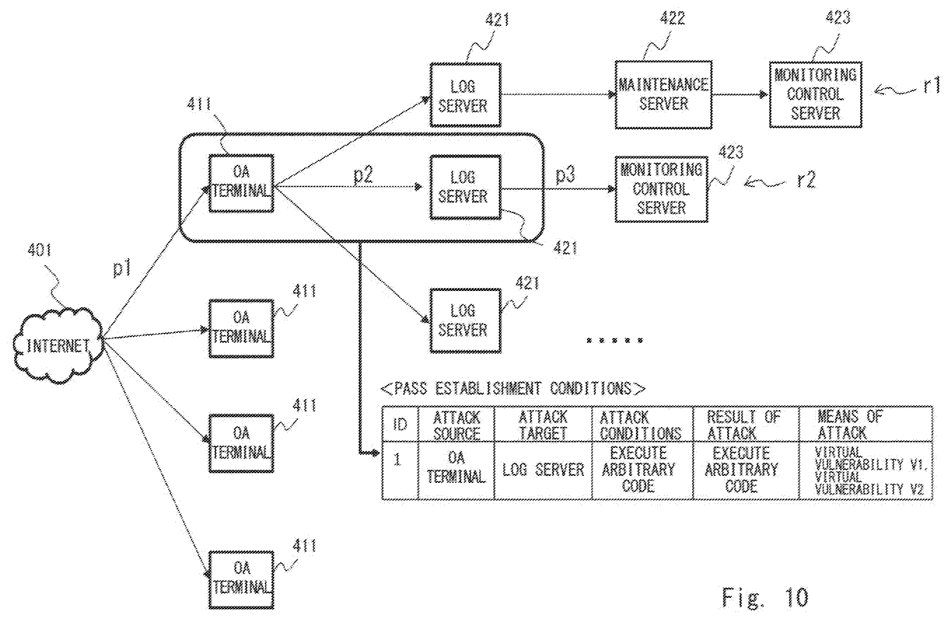

FIG. 10 shows a specific example of an attack graph to be generated. The attack graph shown in FIG. 10 includes all attack routes from the internet 401 to the attack target with the internet 401 being the intrusion point. For instance, the attack routes r1 and r2 are examples of the attack routes from the internet 401 to the monitoring control server 423. The attack route r1 is a route of intrusion from the internet 401 to attack the monitoring control server 423 via the OA terminal 411, the log server 421, and the maintenance server 422. The attack route r1 is a route of intrusion from the internet 401 to attack the monitoring control server 423 via the OA terminal 411 and the log server 421.

The attack route consists of attack paths between nodes. Each attack path has the path establishment conditions set for node-to-node attacks to be established. For example, the attack route r2 includes an attack path p1 between the internet 401 and the OA terminal 411, an attack path p2 between the OA terminal 411 and the log server 421, and an attack path p3 between the log server 421 and the monitoring control server 423. That is, when attack paths p1 to p3 subsequently receive attacks that meet the path establishment conditions, attack to the attack target succeeds along the attack route r2. As shown in FIG. 10, the path establishment conditions of the attack path includes, for example, the attack source, the attack target, the attack conditions (the condition of attack source), the result of the attack (the conditions of the attack target), and the means of attack (the virtual vulnerabilities).

Next, the risk visualizing apparatus 100 analyzes the vulnerabilities (S204). The vulnerability analysis unit 105 analyzes the virtual vulnerabilities in the attack route extracted from the attack graph. The vulnerability analysis unit 105 refers to each attack path included in the attack route in the attack graph and grasps all virtual vulnerabilities (a list of vulnerabilities) in the attack route from the starting point of the attack to the end of the attack. All attack routes included in the attack graph may be analyzed or only the shortest route may be analyzed. By analyzing all attack routes, it is possible to comprehensively analyze potential attack routes. Further, since the shortest route has the highest risk of being attacked, by analyzing only the shortest route, it is possible to effectively analyze the vulnerabilities of high risk.

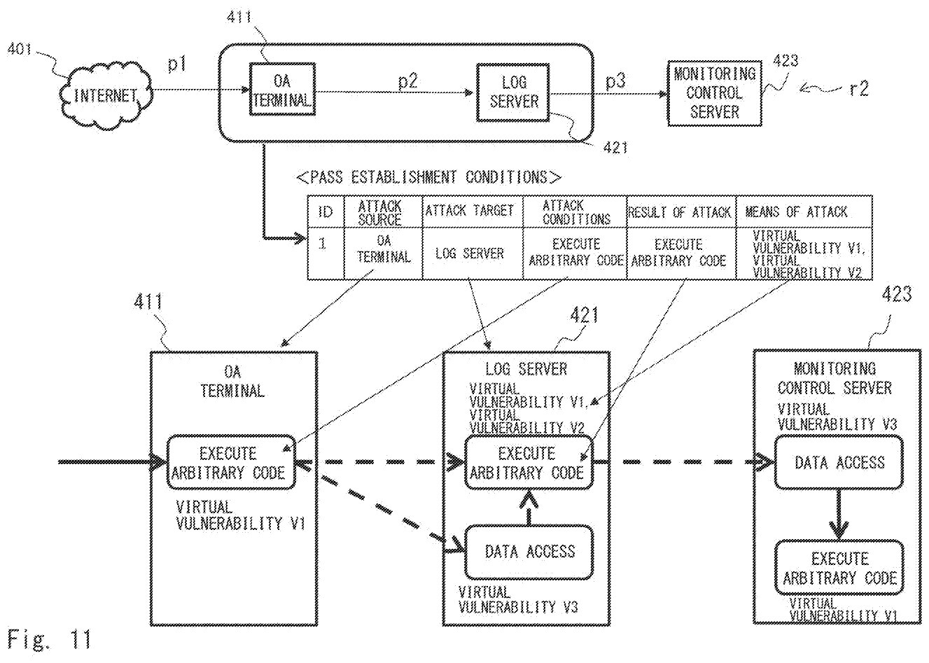

FIG. 11 shows an example of virtual vulnerabilities grasped in the attack route. For example, assuming that the attack route r2 is the shortest route and referring to the attack path p2 of the attack route r2, the path establishment conditions of the attack path p2 includes an OA terminal for the attack source, a log server for the attack target, execution of arbitrary code on the attack conditions, execution of arbitrary code on the attack results, and virtual vulnerability V1 and virtual vulnerability V2 for means of attack. The virtual vulnerabilities V1 and V2 are any type of the virtual vulnerabilities shown in, for example, FIG. 5. From this path establishment conditions, as the vulnerabilities for the attack path p2 to be established, the virtual vulnerability V1 that enables an arbitrary code execution on the OA terminal 411 and the virtual vulnerability V1 and the virtual vulnerability V2 that enable an arbitrary code execution on the log server 421 are grasped. In the example shown in FIG. 11, as the vulnerabilities for the attack path p2 and the attack path p3 to be established, the virtual vulnerability V3 that enables the data access by the log server 421 and the virtual vulnerability V3 that enables the data access by the monitoring control server 423 and the virtual vulnerability V1 that enables arbitrary code execution are grasped. For example, when arbitrary code execution according to the virtual vulnerability V1 and the virtual vulnerability V2 is performed by the log server 421 after the arbitrary code execution according to the virtual vulnerability V1 is performed by the OA terminal 411, or when arbitrary code execution according to the virtual vulnerability V1 and the virtual vulnerability V2 is performed after data access according to the virtual vulnerability V3 is performed by the log server 421, the monitoring control server 423 can be accessed. Further, the monitoring control server 423 performs data access according to the virtual vulnerability V3 and when arbitrary code execution is performed according to the virtual vulnerability V1, the final critical assets are affected. In the present example embodiment, based on the virtual vulnerability that causes establishment of the potential attack route that could affect the critical assets, the vulnerability to be monitored is discriminated.

The risk visualizing apparatus 100 checks whether the virtual vulnerabilities are vulnerabilities that are already-discovered/previously-undiscovered (S205), and when the virtual vulnerability is vulnerability that is previously-undiscovered, such previously-undiscovered vulnerability (the vulnerability type) is to be monitored (S206). The vulnerability analysis unit 105 refers to the vulnerability information DB 300 that stores the already-discovered vulnerabilities and confirms whether each virtual vulnerability (the vulnerability type) that has been grasped in the attack route is the vulnerability that has been already discovered or not. For instance, the vulnerability information DB 300 stores the vulnerability information including the vulnerability type of the vulnerability that is already discovered (disclosed). The vulnerability type (the attack category and the impact of exploitation) of the virtual vulnerability and the vulnerability type of the already-discovered vulnerability are compared and whether the vulnerabilities match each other are checked for. When there is no applicable vulnerability present in the vulnerability information DB 300, that is, when the virtual vulnerability in the attack route is previously-undiscovered vulnerability, such previously-undiscovered virtual vulnerability (the vulnerability type) is determined as vulnerability that could establish an attack route and is to be monitored. Note that the already-discovered vulnerability may be included in the vulnerability to be monitored as necessary.

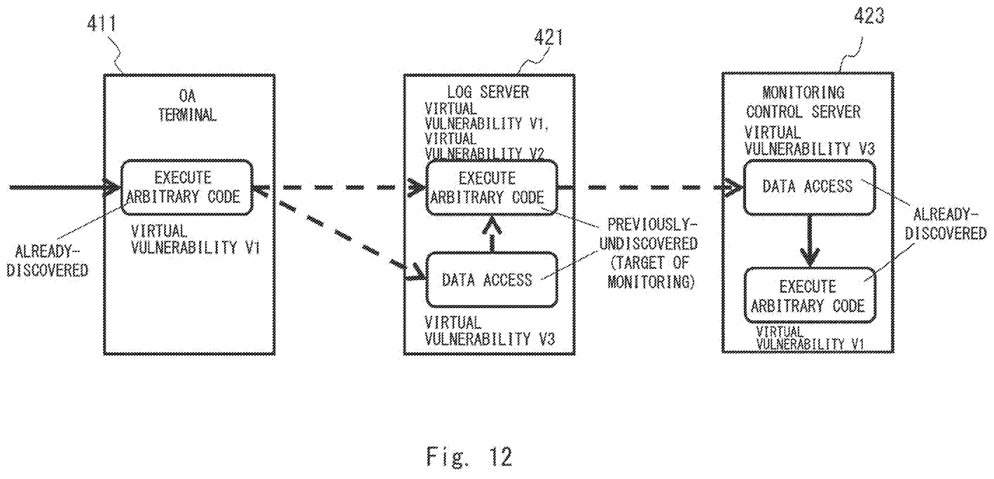

For example, as shown in FIG. 12, assume that the virtual vulnerability V1 of the OA terminal 411 and the virtual vulnerabilities V1 and V3 of the monitoring control server 423 are already-discovered vulnerabilities, and the virtual vulnerabilities V1 to V3 of the log server 421 are previously-undiscovered vulnerabilities. Then, when the virtual vulnerabilities V1 to V3 of the log server 421 that are vulnerabilities that previously undiscovered but later discovered as new vulnerabilities, an attack route will be established and so the virtual vulnerabilities V1 to V3 of the log server 421 are vulnerabilities to be monitored.

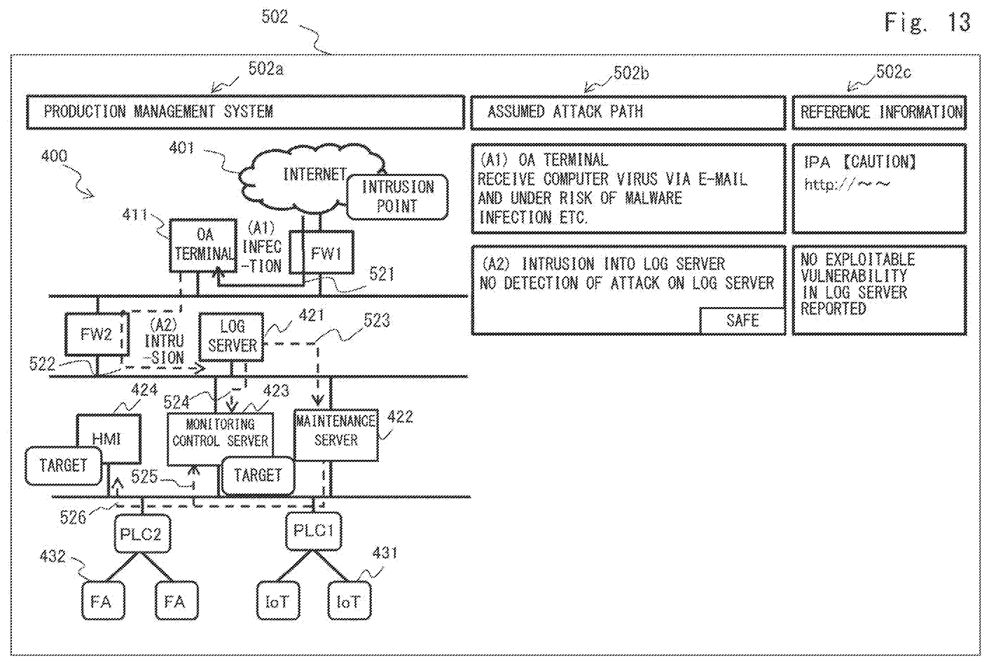

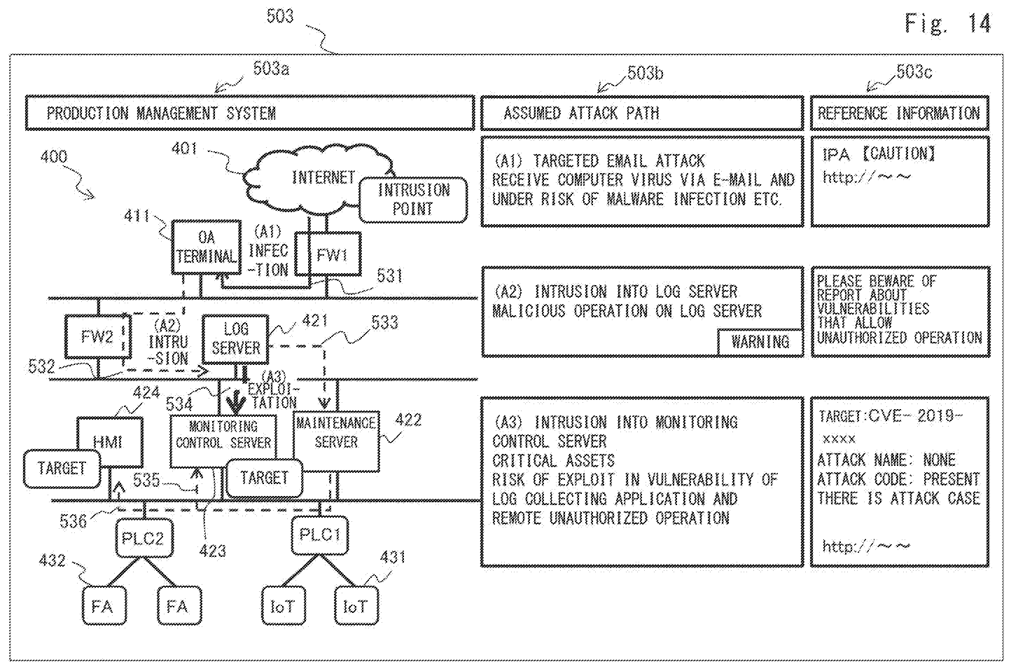

Next, the risk visualizing apparatus 100 displays the analysis result (S207). The display unit 106 displays the vulnerability (the vulnerability type) to be monitored in the information system 400 and the attack route which includes the vulnerability in an identifiable manner. Further, only potential attack routes may be displayed, or the vulnerabilities to be monitored in the potential attack routes may be displayed. FIGS. 13 and 14 show the display examples of the analysis results.

FIG. 13 is an example in which only the potential attack routes are displayed. As shown in FIG. 13, a display screen 502 includes, for example, a system information display region 502a, an attack route information display region 502b, and a reference information display region 502c.

The system information display region 502a displays the system configuration analyzed by the information system 400, displays the set intrusion point and the attack target, and displays the extracted attack route from the intrusion point to the attack target. Among the attack routes, the attack paths which include already-discovered vulnerabilities (the attack paths that are already existing) and the attack paths which include previously-undiscovered vulnerabilities (the potential paths for which vulnerabilities that are exploitable are not discovered) are displayed distinguishably.

For instance, the attack path 521 between the internet 401 and the OA terminal 411 is an attack path which includes already-discovered vulnerabilities and is shown by a solid line (e.g. a red solid line). Further, since the attack paths 522 to 526 from the OA terminal 411 to the monitoring control server 423 and the HMI 424 are attack paths which include previously-undiscovered vulnerabilities (non-attack routes), they are shown by dashed lines (e.g. blue dashed lines).

Further, the attack steps (the procedure of attack) in the analyzed attack route are displayed. For example, in the attack step A1, it is displayed that there is a possibility of the OA terminal 411 being infected with an email virus, and in the attack step A2, it is displayed that that the log server 421 cannot be intruded owing to the firewall FW2.

The attack route information display region 502b displays detailed information (such as risks etc.) with respect to the attack route displayed in the system information display region 502a. Such display is performed in correspondence with the attack steps in the attack route displayed in the system information display region 502a. The risk due to the attack path which includes the already-discovered vulnerabilities and the risk due to the attack path which includes previously-undiscovered vulnerabilities are displayed distinguishably (by changing colors or the like). For instance, in the display of the attack step A1, it is explained that there is a risk of the OA terminal 411 being attacked. Further, in the display of the attack step A2, it is explained that there is no risk of the system being intruded further than the log server 421. In the attack step A2, a mark or the like indicating safety is displayed.

The reference information display region 502c displays the reference information with respect to the detailed information of the attack route displayed in the attack route information display region 502b. Display is performed in correspondence with the attack steps in the attack route in the similar manner as that performed in the attack route information display region 502b. For example, in the attack step A1, since the attack route includes already-discovered vulnerabilities, as the reference information, link information (information source) of a website whose vulnerabilities are made public and the like are displayed as the reference information.

FIG. 14 is an example showing vulnerabilities that reveal the attack routes. As shown in FIG. 14, a display screen 503 includes, like the display screen shown in FIG. 13, a system information display region 503a, an attack route information display region 503b, and a reference information display region 503c.

The system information display region 503a displays the system configuration and the attack route of the analyzed information system 400 like in the display example shown in FIG. 13. The attack path 531 is indicated by a solid line and the attack paths 532 to 536 are indicated by dashed lines. In this example, the attack path 534 includes already-discovered vulnerabilities (vulnerabilities to be monitored) but since the attack path 534 is not connected to serve as an attack route, the attack path is indicated by bold dashed lines (e.g. red dashed lines). Further, as the attack steps in the attack route, it is displayed in the attack step A1 that the OA terminal 411 is infected with an email virus, in the attack step A2 that the log server 421 is under a risk of being intruded, and in the attack step A3 that the monitoring control server 423 is under a risk of being exploited of its vulnerabilities. In the attack step A2, when vulnerabilities are discovered, the attack route is connected whereby the attack path is shown in bold (e.g. blue bold letters).

Like in FIG. 13, the attack route information display region 503b displays detailed information corresponding to the attack steps in the attack route displayed in the system information display region 503a. For instance, in the display of the attack step A1, it is described that there a risk of the OA terminal 411 being attacked. Further, in the display of the attack step A2, when vulnerability is discovered, it is explained that there is a risk of the log server 421 being intruded. In the attack step A2, a mark or the like is displayed indicating that vulnerabilities are not yet discovered but attention needs to be paid thereto. In the display of the attack step A3, it is explained that there is a risk of the monitoring control server 423, which is set as the attack target, being intruded after the attack step A2. Further, damage caused to the business may be displayed as the final result of attack.

The reference information display region 503c displays the reference information corresponding to the attack steps in the attack route displayed in the attack route information display region 503b like in the display example shown in FIG. 13. For example, in the attack step A1 and the attack step A3, reference information related to the already-discovered vulnerabilities is displayed. In the attack step A2, it is displayed that attention needs to be paid to the vulnerability information since the system may be intruded if vulnerability is discovered.

<Effect>

As described above, in the present example embodiments, virtual vulnerabilities including all vulnerability types are set in every node of the information system, potential attack route is extracted using the attack graph generation technique, and the virtual vulnerabilities in the potential attack route is grasped. Based on whether the virtual vulnerability is the already-discovered/previously-undiscovered virtual vulnerability, when new vulnerability is discovered, discrimination is performed as to the possibility of the attack route being established. By this configuration, there is no need to confirm the impact of all the vulnerabilities that are discovered on the information system, and it is possible to manage vulnerabilities of the information system by only confirming (monitoring) the vulnerabilities that are determined in the present example embodiment, whereby it is possible to reduce the burden of management work.

### Other Example Embodiments

The analysis method according to the first example embodiment may be implemented on a periodic basis. Since the database of the vulnerability information is updated as needed to thereby add new vulnerabilities, it is desirable to analyze vulnerabilities using more recent information. For example, the previous analysis result is stored in the storage device and by repeating determination as to whether the virtual vulnerabilities are those that are already-discovered/previously-undiscovered on a periodic basis, it is possible to detect that the vulnerability included in the attack route is newly discovered vulnerability. That is, the risk visualizing apparatus 100 may include a notification unit (an output unit) that refers to the vulnerability information DB 300, detects whether or not vulnerability determined to be monitored is the newly discovered vulnerability, and issues a notification when the vulnerability is the newly discovered vulnerability.

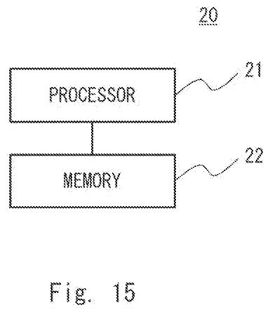

Note that each of the configurations in the above-described example embodiments is constituted by hardware and/or software, and may be constituted by one piece of hardware or software, or may be constituted by a plurality of pieces of hardware or software. As shown in FIG. 15, each apparatus and each function (processing) may be implemented by a computer 20 including a processor 21 such as a CPU (Central Processing Unit) and a memory 22 as a storage device. For example, programs (analysis programs) for performing the method according to the example embodiments may be stored in the memory 22, and each function may be implemented by the processor 21 executing the programs stored in the memory 22.

These programs can be stored and provided to a computer using any type of non-transitory computer readable media. Non-transitory computer readable media include any type of tangible storage media. Examples of non-transitory computer readable media include magnetic storage media (e.g. floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (programmable ROM), EPROM (Erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a wireless communication line.

Note that the present disclosure is not limited to the above-described example embodiments, and can be appropriately changed without departing from the spirit of the present disclosure.

The present disclosure has been described with reference to the example embodiments. However, it should be noted that the present disclosure is not to be limited in any way by the example embodiments described above. The configuration and the details of the present disclosure can be modified in various ways that can be understood by one skilled in the art within the scope of present disclosure.

The whole or part of the example embodiments disclosed above can be described as, but not limited to, the following supplementary notes.

(Supplementary Note 1)

An analysis apparatus comprising:

setting means for setting virtual vulnerabilities in a plurality of nodes configuring an information system to be analyzed;

extraction means for extracting an attack route of the information system based on the set virtual vulnerabilities; and

discrimination means for discriminating vulnerabilities to be monitored based on the virtual vulnerabilities in the extracted attack route.

(Supplementary Note 2)

The analysis apparatus as described in Supplementary note 1, wherein the virtual vulnerabilities include vulnerability types into which the vulnerabilities are pseudo-classified.

(Supplementary Note 3)

The analysis apparatus as described in Supplementary note 2, wherein the virtual vulnerabilities include possible vulnerability types into which the vulnerabilities are classified.

(Supplementary Note 4)

The analysis apparatus as described in Supplementary note 3, wherein each of the vulnerability types includes a type of intrusion method or a type of result of attack.

(Supplementary Note 5)

The analysis apparatus as described in Supplementary note 4, wherein each of the virtual vulnerabilities is a combination of the type of intrusion method and the type of result of attack.

(Supplementary Note 6)

The analysis apparatus as described in Supplementary note 4 or 5, wherein the intrusion method includes a remote attack or a local attack.

(Supplementary Note 7)

The analysis apparatus as described in any one of Supplementary notes 4 to 6, wherein the result of attack includes arbitrary code execution, data access, data tampering, and DoS (Denial of Service).

(Supplementary Note 8)

The analysis apparatus as described in any of Supplementary notes 1 to 7, wherein the extraction means generates an attack graph based on the virtual vulnerabilities and extracts the attack route from the generated attack graph.

(Supplementary Note 9)

The analysis apparatus as described in Supplementary note 8, wherein the generated attack graph includes conditions for establishing an attack path between the plurality of nodes.

(Supplementary Note 10)

The analysis apparatus as described in Supplementary note 9, wherein the discrimination means grasps the virtual vulnerabilities in the attack path based on the conditions for establishing the attack path.

(Supplementary Note 11)

The analysis apparatus as described in Supplementary note 10, wherein the discrimination means grasps the virtual vulnerabilities in all attack routes that are included in the attack graph.

(Supplementary Note 12)

The analysis apparatus as described in Supplementary note 10, wherein the discrimination means grasps the virtual vulnerability in the shortest route among the attack routes included in the attack graph.

(Supplementary Note 13)

The analysis apparatus as described in any of Supplementary notes 1 to 12, wherein the discrimination means discriminates the vulnerability to be monitored based on whether the virtual vulnerability in the attack route is vulnerability that is already discovered or not.

(Supplementary Note 14)

The analysis apparatus as described in Supplementary note 13, wherein when the virtual vulnerability in the attack route is not vulnerability that is already-discovered vulnerability, the discrimination means determines that the vulnerability is vulnerability to be monitored.

(Supplementary Note 15)

The analysis apparatus as described in any of Supplementary notes 1 to 14, further comprising output means for outputting the discriminated vulnerability to be monitored.

(Supplementary Note 16)

The analysis apparatus as described in Supplementary note 15, wherein the output means distinguishably displays the vulnerability to be monitored and other vulnerabilities in the attack route.

(Supplementary Note 17) An analysis method comprising:

setting virtual vulnerabilities in a plurality of nodes configuring an information system to be analyzed;

extracting an attack route of the information system based on the set virtual vulnerabilities; and

discriminating vulnerabilities to be monitored based on the virtual vulnerabilities in the extracted attack route.

(Supplementary Note 18)

The analysis method as described in Supplementary note 17, wherein the virtual vulnerabilities include vulnerability types into which the vulnerabilities are pseudo-classified.

(Supplementary Note 19)

An analysis program for causing a computer to execute the processing of:

setting virtual vulnerabilities in a plurality of nodes configuring an information system to be analyzed;

extracting an attack route of the information system based on the set virtual vulnerabilities; and

discriminating vulnerabilities to be monitored based on the virtual vulnerabilities in the extracted attack route.

(Supplementary Note 20)

The analysis program as described in Supplementary note 19, wherein the virtual vulnerabilities include vulnerability types into which the vulnerabilities are pseudo-classified.

### REFERENCE SIGNS LIST

1 ANALYSIS SYSTEM
10 ANALYSIS APPARATUS
11 SETTING UNIT
12 EXTRACTION UNIT
13 DISCRIMINATION UNIT
20 COMPUTER
21 PROCESSOR
22 MEMORY
100 RISK VISUALIZING APPARATUS
101 VIRTUAL VULNERABILITY SETTING UNIT
102 ANALYSIS ELEMENT SETTING UNIT
103 ATTACK ROUTE ANALYSIS UNIT
104 ATTACK ROUTE EXTRACTION UNIT
105 VULNERABILITY ANALYSIS UNIT
106 DISPLAY UNIT
200 SYSTEM CONFIGURATION INFORMATION DB
300 VULNERABILITY INFORMATION DB
400 INFORMATION SYSTEM
401 INTERNET
410 INFORMATION NETWORK
411 OA TERMINAL
420 CONTROL NETWORK
421 LOG SERVER
422 MAINTENANCE SERVER
423 MONITORING CONTROL SERVER
424 HMI
430 FIELD NETWORK
431 IoT DEVICE
432 FA DEVICE
501, 502, 503 DISPLAY SCREEN
502a, 503a SYSTEM INFORMATION DISPLAY REGION
502b, 503b ATTACK ROUTE INFORMATION DISPLAY REGION
502c, 503c REFERENCE INFORMATION DISPLAY REGION
FW1, FW2 FIREWALL
PLC1, PLC2 PROGRAMMABLE LOGIC CONTROLLER

What is claimed is:

1. An analysis apparatus comprising:
a memory storing instructions, and
a processor configured to execute the instructions stored in the memory to;
set virtual vulnerabilities in a plurality of nodes configuring an information system to be analyzed;
extract an attack route of the information system based on the set virtual vulnerabilities; and
discriminate vulnerabilities to be monitored based on the virtual vulnerabilities in the extracted attack route.

2. The analysis apparatus according to claim 1, wherein the virtual vulnerabilities include vulnerability types into which the vulnerabilities are pseudo-classified.

3. The analysis apparatus according to claim 2, wherein the virtual vulnerabilities include possible vulnerability types into which the vulnerabilities are classified.

4. The analysis apparatus according to claim 3, wherein each of the vulnerability types includes a type of intrusion method or a type of result of attack.

5. The analysis apparatus according to claim 4, wherein each of the virtual vulnerabilities is a combination of the type of intrusion method and the type of result of attack.

6. The analysis apparatus according to claim 4, wherein the intrusion method includes a remote attack or a local attack.

7. The analysis apparatus according to claim 4, wherein the result of attack includes arbitrary code execution, data access, data tampering, and DoS (Denial of Service).

8. The analysis apparatus according to claim 1, wherein the processor is further configured to execute the instructions stored in the memory to generates an attack graph based on the virtual vulnerabilities and extract the attack route from the generated attack graph.

9. The analysis apparatus according to claim 8, wherein the generated attack graph includes conditions for establishing an attack path between the plurality of nodes.

10. The analysis apparatus according to claim 9, wherein the processor is further configured to execute the instructions stored in the memory to grasp the virtual vulnerabilities in the attack path based on the conditions for establishing the attack path.

11. The analysis apparatus according to claim 10, wherein the processor is further configured to execute the instructions stored in the memory to grasp the virtual vulnerabilities in all attack routes that are included in the attack graph.

12. The analysis apparatus according to claim 10, wherein the processor is further configured to execute the instructions stored in the memory to grasp the virtual vulnerability in the shortest route among the attack routes included in the attack graph.

13. The analysis apparatus according to claim 1, the processor is further configured to execute the instructions stored in the memory to discriminate the vulnerability to be monitored based on whether the virtual vulnerability in the attack route is vulnerability that is already discovered or not.

14. The analysis apparatus according to claim 13, wherein the processor is further configured to execute the instructions stored in the memory to, when the virtual vulnerability in the attack route is not vulnerability that is already-discovered vulnerability, determine that the vulnerability is vulnerability to be monitored.

15. The analysis apparatus according to claim 1, wherein the processor is further configured to execute the instructions stored in the memory to output the discriminated vulnerability to be monitored.

16. The analysis apparatus according to claim 15, wherein the processor is further configured to execute the instructions stored in the memory to distinguishably display the vulnerability to be monitored and other vulnerabilities in the attack route.

17. An analysis method comprising:
setting virtual vulnerabilities in a plurality of nodes configuring an information system to be analyzed;
extracting an attack route of the information system based on the set virtual vulnerabilities; and
discriminating vulnerabilities to be monitored based on the virtual vulnerabilities in the extracted attack route.

18. The analysis method according to claim 17, wherein the virtual vulnerabilities include vulnerability types into which the vulnerabilities are pseudo-classified.

19. A non-transitory computer readable medium storing an analysis program for causing a computer to execute the processing of:
setting virtual vulnerabilities in a plurality of nodes configuring an information system to be analyzed;
extracting an attack route of the information system based on the set virtual vulnerabilities; and
discriminating vulnerabilities to be monitored based on the virtual vulnerabilities in the extracted attack route.

20. The non-transitory computer readable medium according to claim 19, wherein the virtual vulnerabilities include vulnerability types into which the vulnerabilities are pseudo-classified.
